(19) United States
(12) Patent Application Publication
(10) Pub. No.: US 2005/0034140 A1
(43) Pub. Date: Feb. 10, 2005

(54) LOCKING MECHANISM FOR EXTERNAL OPTICAL DISK DRIVE

(76) Inventor: Yuan-Hu Chang, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/707,515

(22) Filed: Dec. 19, 2003

(30) Foreign Application Priority Data
Aug. 8, 2003 (TW) 092121922

(51) Int. Cl. G11B 17/03

(52) U.S. Cl. 720/655

(57) ABSTRACT

A locking member is positioned on an upper housing to release or lock a cover. A rotary shaft is integrally formed with the cover. Both ends of an elastic member are respectively adapted to be received in holes of the rotary shaft and a mounting member defined on the bottom of the upper housing and adapted to receive the rotary shaft of the cover. In addition, the elastic member is restrained by the rotary shaft and the mounting member. When the cover is closed, the line of force of the elastic member is directed to a connecting rod, and the cover is not subjected to a torsional moment of the elastic member. When the locking member disengages from the opening of the cover, the line of elastic force is not directed to the connecting shaft, and the cover will be opened due to the resilience of the elastic member.

### BACKGROUND OF INVENTION

1. Field of the Invention

The invention relates to a locking mechanism for an external optical disk drive, and in particular to a locking mechanism for releasing or locking a cover of an external optical disk drive.

2. Description of the Prior Art

Optical disk drives are becoming more popular in the market, and have been considered standard equipment on personal computers for several years. Generally speaking, optical disk drives are used to read information stored on an optical disk. Examples of optical disk drives are known as compact disk drives (CD-ROM drives) and digital versatile disk drives (DVD-ROM drives) in the prior art. Some optical disk drives have the additional capability of being able to write data onto an optical disk, i.e., CD-RW drivers. Optical disk drives are used in music and video playback and are implemented in recording devices and other electronic devices.

One type of optical disk drive has an independent housing (often referred as an external type drive) and is coupled to a host computer via a signal cable to transmit data to the host computer. In addition, the external optical disk drive may transmit music data to users via an earphone cable.

FIG. 1 illustrates a conventional external optical disk drive. Referring to FIG. 1, the conventional external optical disk drive includes a cover 1, an upper housing 2, and a lower housing 3.

FIG. 2 illustrates a cover of the conventional external optical disk drive of FIG. 1. Referring to FIG. 2, the cover 1 includes a protrusion 11 extending downwardly from its front end, and an opening 12 is defined in the protrusion 11. A rotary shaft 13 is integrally formed at the rear edge of the cover 1, and a gear rack 14 is integrally formed with the rotary shaft 13 of the cover 1.

FIG. 3 illustrates the conventional external optical disk drive of FIG. 1 with the cover 1 opened. Referring to FIG. 3, the upper housing 2 is positioned at the lower housing 3. The rotary shaft 13 of the cover 1 is pivotally coupled to the upper housing 2 so that the cover 1 can be pivoted with respect to the upper housing 2 and the lower housing 3. To effectively utilize the space occupied by the external optical disk drive, the rotary shaft 13 is not located at a central portion of the rear edge of the cover 1.

FIG. 4 is a perspective view of assembly of the cover 1 and the upper housing 2 of the conventional external optical disk drive as viewed from below the upper housing 2. As shown in FIG. 4, OLE_LINK1a locking member 4 (circled in phantom) is defined on the bottom surface of the upper housing 2. OLE_LINK1 When the cover 1 is closed, the locking member 4 is used to engage with the opening 12 of the protrusion 11 for the purpose of locking the cover 1. Further referring to FIG. 4, a mounting member 21 is positioned on the bottom of the upper housing 2 and is adapted to receive the rotary shaft 13 of the cover 1 and an elastic member 15. The two ends of the elastic member 15 are respectively restrained by the mounting member 21 and the rotary shaft 13 of the cover 2. The elastic member 15 is of metallic material (or plastic) and can be a torsion spring. Besides, the gear rack 14 is adapted to engage with a spur gear (not shown) of the upper housing 2, so the cover 1 can be pivoted about the mounting member 21 because of a torsional moment of the elastic member 15.

However, as described above, the torsional moment of the elastic member 15 is not applied at the central portion of the rear edge of the cover 1, thereby causing deformation of the cover 1. Even worse, deformation of the cover 1 may be aggravated during shipping when the environmental temperature is high, thereby rendering the optical disk drive unusable.

Accordingly, there is a need to develop an improved locking mechanism for use in an external optical disk drive.

### SUMMARY OF INVENTION

It is an object of the present invention to provide a locking mechanism for an external optical disk drive that can effectively eliminate deformation of a cover.

It is another object of the present invention to provide an external optical disk drive having a locking mechanism that is used to release or lock a cover smoothly.

In order to accomplish the object of the present invention, the present invention provides a locking mechanism for use in an optical disk drive. The locking member is positioned on the upper housing to release or lock the cover. The cover has a projection extending downwardly from its front end and a rotary shaft is integrally formed with the cover. A mounting member is defined on the bottom of the upper housing and is adapted to receive the rotary shaft of the cover. Both ends of the elastic member are respectively adapted to be received in holes of the rotary shaft and the mounting member. In addition, the elastic member is restrained by the rotary shaft and the mounting member. When the cover is closed, the line of force of the elastic member is directed to a connecting rod, and the cover is not subjected to torsional moment of the elastic member. When the locking member disengages from the opening of the cover, the line of elastic force is not directed to the connecting shaft, and the cover will be opened due to the resilience of the elastic member. Thus, there is no force or torsional moment applied to the cover.

### BRIEF DESCRIPTION OF DRAWINGS

The present invention can be fully understood from the following detailed description and preferred embodiment with reference to the accompanying drawings in which:

FIG. 1 is a perspective view of a conventional external optical disk drive;

FIG. 2 is a perspective view of a cover for use in the conventional external optical disk drive of FIG. 1;

FIG. 3 is a perspective view of a conventional external optical disk drive of FIG. 1 with the cover opened;

FIG. 4 is a perspective view of a locking mechanism of the conventional external optical disk drive of FIG. 1 as viewed from below the upper housing;

FIG. 5 is an exploded perspective view of an external optical disk drive in accordance with the present invention;

FIG. 6A is a perspective view of a locking mechanism of the external optical disk drive of FIG. 5 as viewed from the bottom of the upper housing;

FIG. 6B is a sketch of four-bar linkage corresponding to the mechanism of FIG. 6A with the cover closed;

FIG. 7A is a perspective view of a locking mechanism of the external optical disk drive of FIG. 5 as viewed from the bottom of the upper housing; and

FIG. 7B is a sketch of four-bar linkage corresponding to the mechanism of FIG. 7A with the cover opened.

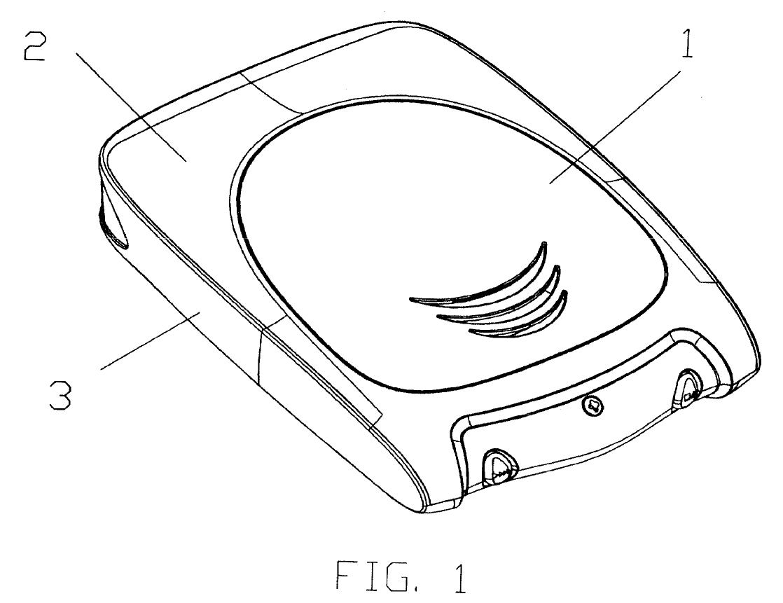

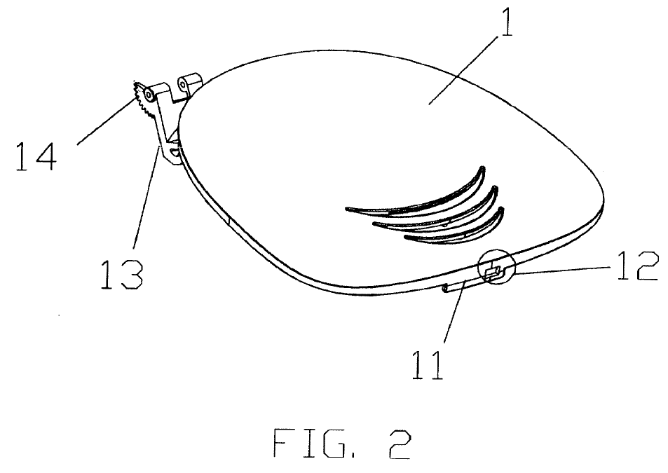

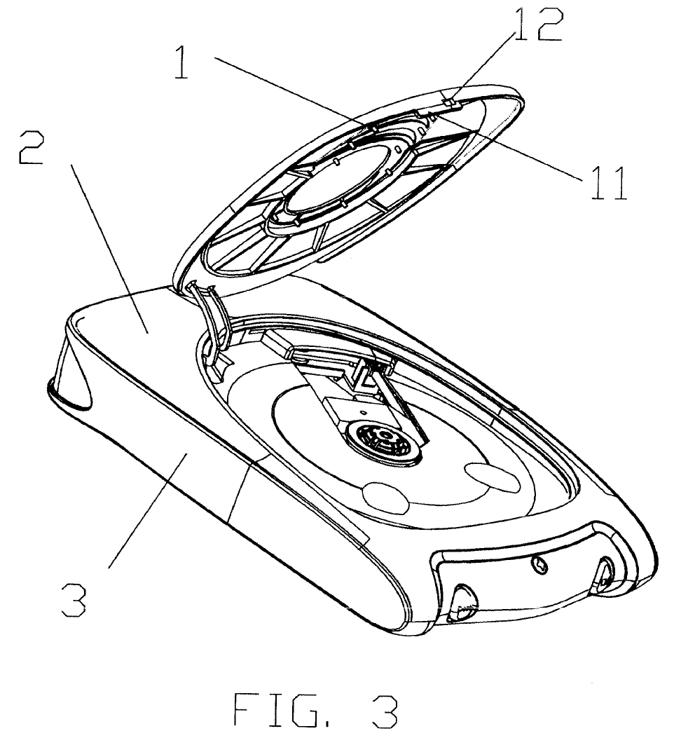

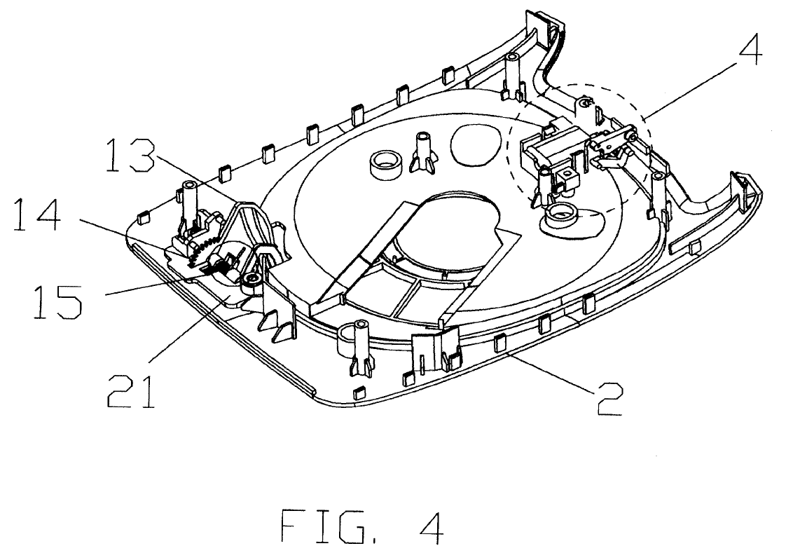

### DETAILED DESCRIPTION

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

Although the embodiments of the present invention are described below in connection with external DVD-ROM drives, the present invention can be applied to all optical disk drive types, including but not limited to CD-ROM drives, CD-RW drives, DVD-RAM drives, DVD-RW drives, DVD+RW drives, COMBO drives, car audio players, external drives, as well as all other optical media recorders and players.

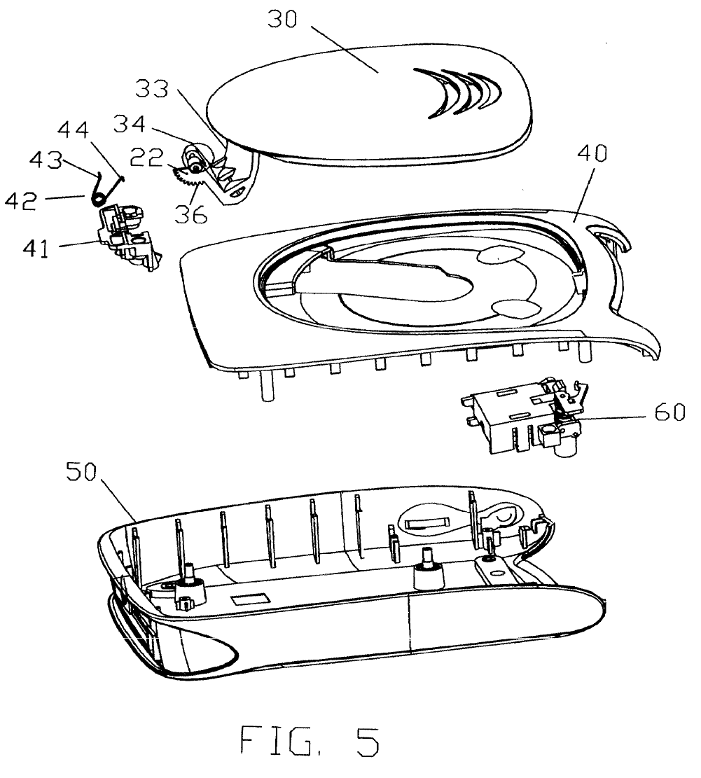

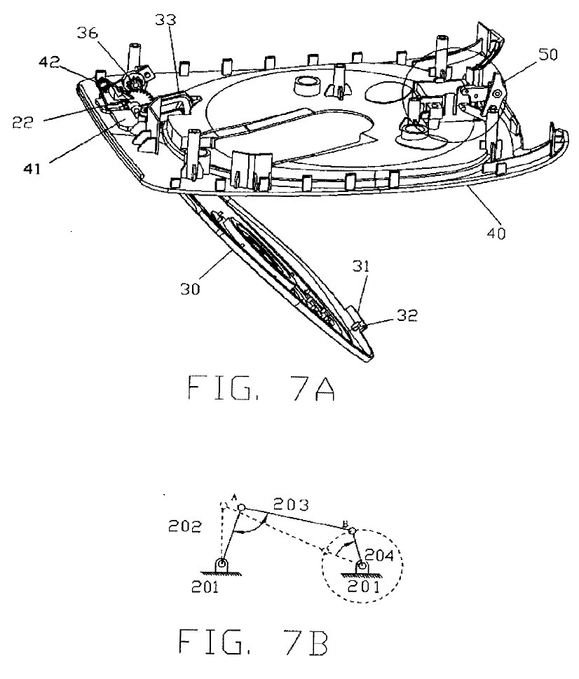

FIG. 5 is an exploded perspective view of an external optical disk drive in accordance with the present invention. For simplicity, a playback unit is removed from the external optical disk drive, and the description about the playback unit is omitted. Referring to FIG. 5, the external optical disk drive of the present invention includes a cover 30, an upper housing 40, a lower housing 50, and a locking member 60. The upper housing 40, the lower housing 50, and the locking member 60 of the present invention can be the same as the upper housing 2, the lower housing 3, and the locking member 4 of the conventional optical disk drive. As described above, the upper housing 40 is positioned at the lower housing 50. Referring to FIGS. 5 and 7A, the cover 30 includes a protrusion 31 extending downwardly from its front end, and an opening 32 is defined in the protrusion 31. A rotary shaft 33 is integrally formed at the rear edge of the cover 30, and a gear rack 36 is integrally formed with the rotary shaft 33 of the cover 30.

Further referring to FIG. 5, a mounting member 41 is positioned on the bottom of the upper housing 40 and is adapted to receive a connecting portion 34 that is integrally formed with the rotary shaft 33. Thus, the rotary shaft 33 of the cover 30 is pivotally coupled to the upper housing 40 so that the cover 30 can be pivoted with respect to the upper housing 40 and the lower housing 50. Further, the external optical disk drive of the present invention includes an elastic member 42 having two connecting ends 43 and 44. A hole 22 is defined on the rotary shaft 33 of the cover 30 and positioned near the connecting portion 34. The hole 22 is adapted to receive the connecting end 43 of the elastic member 42, and the mounting member 41 is adapted to fasten the connecting end 44 of the elastic member 42. Thus, the two connecting ends 43 and 44 of the elastic member 42 are respectively restrained by the mounting member 41 and the rotary shaft 33 of the cover 30, and a torsional moment of the elastic member 42 is produced. The elastic member 42 is of metallic material (or plastic) and can be a torsion spring.

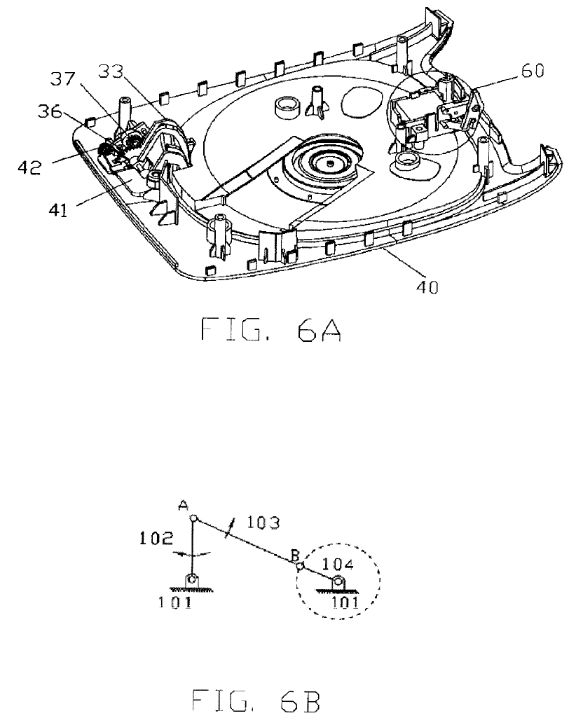

FIG. 6A illustrates the interconnection of the various components of a locking mechanism in accordance with the present invention as viewed from the bottom of the upper housing 40. Referring to FIG. 6A, the gear rack 36 is integrally formed with the rotary shaft 33 of the cover 30 and is adapted to engage with a spur gear 37 that is pivotally connected to the mounting member 41. When the cover 30 is closed, the connecting end 43 of the elastic member 42 is restrained by the hole 22 of the rotary shaft 33 and the connecting end 44 of the elastic member 42 is fastened at the mounting member 41. Obviously, the connecting end 43 of the elastic member 42 is directed to the connecting portion 34 of the rotary shaft 33.

FIG. 6B illustrates a four-bar linkage corresponding to the locking mechanism of FIG. 6A with the cover 30 closed. Referring to FIG. 6B, link 101 generally indicates a frame, or ground, and link 101 is generally stationery. According to the present invention, when the cover 30 is opened or closed, the upper housing 40 is stationery. Thus, the link 101 is the upper housing 40. In addition, a link 102 and a link 103 respectively indicate the connecting ends 44 and 43 of the elastic member 42. A link 104 also indicates the cover 30 of the present invention. Further referring to FIGS. 6A and 6B, when the cover 30 of the optical disk drive is closed, the connecting end 43 of the elastic member 42 is directed to the connecting portion 34 of the rotary shaft 33. That is, a joint B indicates the connecting portion 34, and the line of force of the link 103 is directed along the link 104. Thus, a dead point occurs, and the torsional moment of the elastic member 42 is not applied at the rotary shaft 33 of the cover 30, and the opening 32 of the cover 30 is merely locked by the locking member 60. The cover 30 will not be damaged by the torsional moment of the elastic member 42.

FIG. 7A illustrates the interconnection of the various components of a locking mechanism in accordance with the present invention as viewed from below the upper housing 40. Referring to FIG. 7A, as described above, the gear rack 36 is integrally formed with the rotary shaft 33 of the cover 30 and is adapted to engage with the spur gear 37 that is positioned at the mounting member 41. When the cover 30 is released by the locking member 60 and the cover 30 is opened, the connecting end 43 of the elastic member 42 is restrained by the hole 22 of the rotary shaft 33. The connecting end 43 of the elastic member 42 is no longer directed to the connecting portion 34 of the rotary shaft 33. Then, the cover 30 can be pivoted about the mounting member 41 because of the resilience of the elastic member 42.

FIG. 7B illustrates a four-bar linkage corresponding to the locking mechanism of FIG. 7A with the cover 30 opened. Referring to FIG. 7B, link 201 generally indicates a frame, or ground, and link 201 is generally stationery. According to the present invention, when the cover 30 is opened or closed, the upper housing 40 is stationery. Thus, the link 201 is the upper housing 40. In addition, the link 202 and the link 203 respectively indicate the connecting ends 43 and 44 of the elastic member 42. The link 204 also indicates the cover 30 of the present invention. Further referring to FIGS. 7A and 7B, when the cover 30 of the optical disk drive is released and the locking member 60 disengages from the opening 32 of the cover 30, the connecting end 43 of the elastic member 42 is not directed to the connecting portion 34 of the rotary shaft 33. Thus, a dead point will not occur, and the torsional moment of the elastic member 42 is applied at the rotary shaft 33 of the cover 30. The cover 30 can be pivoted with respect to the upper housing 30 and the lower housing 40 because of the resilience of the elastic member 42.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

1. A locking mechanism for an external optical disk drive with a cover and an upper housing, comprising:
an elastic member, having two connecting ends;
a rotary shaft, integrally formed with the cover and having a hole adapted to receive one of the connecting ends;
a locking member, positioned on the upper housing; and
a mounting member, positioned on the upper housing and adapted to fasten the other one of the connecting ends.

2. The locking mechanism as claimed in claim 1, wherein the elastic member is of metallic material and can be a torsion spring.

3. The locking mechanism as claimed in claim 1, wherein the elastic member is of plastic and can be a torsion spring.

4. The locking mechanism as claimed in claim 1, further comprising a gear rack that is integrally formed with the rotary shaft of the cover.

5. The locking mechanism as claimed in claim 4, further comprising a spur gear that is positioned on the mounting member and is adapted to engage with the gear rack.

6. A locking mechanism for an external optical disk drive with a cover and an upper housing, comprising:
an elastic member, having two connecting ends;
a rotary shaft, integrally formed with the cover and having a hole adapted to receive one of the connecting ends;
a gear rack, integrally formed with the rotary shaft;
a mounting member, positioned on the upper housing and adapted to fasten the other one of the connecting ends;
a spur gear, positioned on the mounting member and adapted to engage with the gear rack; and
a locking member, positioned on the upper housing.

7. The locking member as claimed in claim 6, wherein the elastic member is of metallic material and can be a torsion spring.

8. The locking mechanism as claimed in claim 6, wherein the elastic member is of plastic and can be a torsion spring.

9. An external optical disk drive, comprising:
a lower housing;
an upper housing, positioned at the lower housing;
a locking member, positioned on the upper housing;
an elastic member, having two connecting ends;
a cover, having a rotary shaft and a gear rack and having a hole to be adapted to receive one of the connecting ends of the elastic member;
a mounting member, positioned on the upper housing and adapted to fasten the other one of the connecting ends; and
a spur gear, positioned at the mounting member;
wherein the cover is opened or closed, the spur gear will engage with the gear rack of the cover.

10. The external optical disk drive as claimed in claim 9, wherein the elastic member is of metallic material and can be a torsion spring.

11. The external optical disk drive as claimed in claim 9, wherein the elastic member is of plastic and can be a torsion spring.
